(19) United States
(12) Patent Application Publication
(10) Pub. No.: US 2011/0148848 A1
(43) Pub. Date: Jun. 23, 2011

(54) OUTPUT DRIVER OF ELECTRONIC PAPER DISPLAY DEVICE

(75) Inventors: Jung-Il SEO, Daejeon-si (KR); Yong-Jung Kwon, Cheongju-si (KR); An-Young Kim, Daejeon-si (KR); Joon-Ho Na, Daejeon-si (KR)

(73) Assignee: SILICON WORKS CO., LTD, Daejeon-si (KR)

(21) Appl. No.: 12/974,553

(22) Filed: Dec. 21, 2010

(30) Foreign Application Priority Data
Dec. 22, 2009 (KR) 10-2009-0129001

(51) Int. Cl. G09G 5/00

(52) U.S. Cl. 345/212; 345/204

(57) ABSTRACT

An output driver of an electronic paper display device includes M number of output driver sections configured to transmit M number of pieces of data, respectively, to the electronic paper display device, wherein the M number of output driver sections are divided into a plurality of groups, and are temporally dispersed and driven according to groups, thereby transmitting the M number of pieces of data to the electronic paper display device. Also, an output driver for transmitting data to an electronic paper display device includes N number of drivers, wherein a part of the N number of drivers are selected and driven according to an output impedance of the electronic paper display device. Since output driver sections are divided into groups and are dispersedly driven, peak current is reduced. Since drivers are selectively driven according to the sizes of output loads, a constant driving capability is provided.

### BACKGROUND OF THE INVENTION

1. Field of the Invention

The present invention relates to an output driver of an electronic paper display device, and more particularly, to an output driver of an electronic paper display device, which can reduce peak current, and can be applied without redesign of the output driver although a resistor-capacitor (RC) output impedance varies.

2. Description of the Related Art

In general, electronic paper is a display device that displays a character or an image on a flexible substrate such as thin plastic in which millions of beads spread in oil holes. The electronic paper can be re-cycled millions of times, and is expected to replace the existing printed media, such as books, news papers, and magazines in the future.

Also, as compared with the existing flat panel display device, an electronic paper display device is more inexpensive in terms of a production cost, and does not require background light or continuous recharge, differently from a stop screen, so that it can be driven using a very small amount of energy, and accordingly, its energy efficiency is remarkably excellent. In addition, the electronic paper display device can not only provide clear image quality and wide field of view, but also incorporate a memory function of allowing displayed characters and images not to be completely vanished even if the power is shut off. Therefore, the electronic paper display device is expected to be widely used for a public bulletin board, advertisements, electronic books, etc.

The technical approach to realize an electronic paper display panel may be accomplished using liquid crystals, organic electro luminescence (EL), electrophoresis, twist balls, or mechanical reflection-type display. Among them, the technology using electrophoresis is the most notable technology at the present time. The technology using electrophoresis is to insert charged particles and fluid into microcapsules, and to accomplish an image using an electrophoresis phenomenon.

Such electronic paper is flexible because using a substrate made of pliable material, can be easily carried through slimming, and can be easily manufactured in a large size at a low cost due to a simple electrode structure and a simple manufacturing process.

The conventional output driver of the electronic paper display device has a problem in that, as the number of outputs inputted to the electronic paper display device, i.e. the number of channels, increases, peak current increases, so that electromagnetic interference (EMI) and power consumption increase.

Also, since an equal output driver cannot be used for both electronic paper display devices having different output loads, there is a problem in that another output driver must be newly designed, or that a separate output driver product must be used for each electronic paper display device.

### SUMMARY OF THE INVENTION

Accordingly, the present invention has been made in an effort to solve the problems occurring in the related art, and an object of the present invention is to provide an output driver of an electronic paper display device for dividing output driver sections into a plurality of groups and dispersedly driving the output driver sections according to groups, so as to reduce peak current, and selectively driving drivers included in the output driver according to the sizes of an output loads so as to provide a constant driving capability even to products having different loads, and thus to be applied to all products.

In order to achieve the above object, according to one aspect of the present invention, there is provided an output driver of an electronic paper display device, the output driver including: M number of output driver sections configured to transmit M number of pieces of data, respectively, to the electronic paper display device, wherein the M number of output driver sections are divided into a plurality of groups, and are temporally dispersed and driven according to groups, thereby transmitting the M number of pieces of data to the electronic paper display device.

According to another aspect of the present invention, there is provided an output driver for transmitting data to an electronic paper display device, the output driver including: N number of drivers, wherein a part of the N number of drivers are selected and driven according to an output impedance of the electronic paper display device.

### BRIEF DESCRIPTION OF THE DRAWINGS

The above objects, and other features and advantages of the present invention will become more apparent after a reading of the following detailed description taken in conjunction with the drawings, in which:

FIG. 1 is a view illustrating the configuration of an output driver of an electronic paper display device according to a first embodiment of the present invention and an electronic paper display device;

FIG. 2 is a view illustrating the configuration of an output driver of an electronic paper display device according to a second embodiment of the present invention and an electronic paper display device;

FIG. 3 is a view illustrating the configuration of an output driver of an electronic paper display device according to a third embodiment of the present invention and an electronic paper display device;

FIG. 4 is a detailed circuit diagram of a first output driver section shown in FIG. 3; and

FIGS. 5A to 5D are views illustrating dispersion driving models of output driver sections shown in FIG. 3.

### DETAILED DESCRIPTION OF PREFERRED EMBODIMENTS

Reference will now be made in greater detail to a preferred embodiment of the invention, an example of which is illustrated in the accompanying drawings. Wherever possible, the same reference numerals will be used throughout the drawings and the description to refer to the same or like parts.

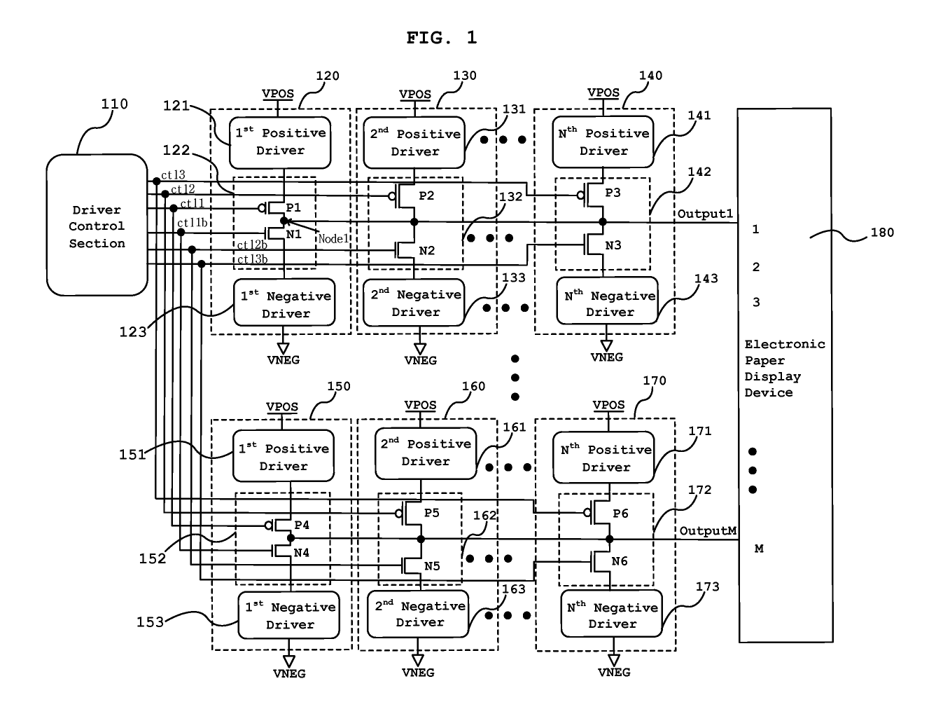

FIG. 1 is a view illustrating the configuration of an output driver of an electronic paper display device according to a first embodiment of the present invention and an electronic paper display device 180.

The output driver of the electronic paper display device, illustrated in FIG. 1, includes a driver control section 110 and output driver sections 120, 130, . . . , 140; . . . ; and 150, 160, . . . , 170.

The output driver sections 120, 130, . . . , 140; . . . ; and 150, 160, . . . , 170 respectively include N number of drivers, and are configured to transmit the respective data Output1, . . . , and OutputM (wherein “N” and “M” are natural numbers), which are generated through selective driving of the respective N drivers, to the electronic paper display device 180.

Among the output driver sections, the output driver section 120, 130, . . . , 140 includes a first driver unit 120 to an N^{th} driver unit 140.

Each of the first driver unit 120 to N^{th} driver unit 140 includes a positive driver, a negative driver, and a switching module.

The switching module may be implemented by connecting a plurality of transistors in series or parallel. FIG. 1 illustrates a case where the switching module is implemented by connecting a PMOS transistor and an NMOS transistor in series.

For example, the first driver unit 120 includes a first positive driver 121, a first negative driver 123, and a first switching module 122, wherein the switching module 122 includes a first PMOS transistor P1 and a first NMOS transistor N1.

The first PMOS transistor P1 receives a first control signal ctl1 through the gate thereof from the driver control section 110, wherein a first terminal of the first PMOS transistor P1 is connected to the first positive driver 121, and a second terminal of the first PMOS transistor P1 is connected to a first terminal of the first NMOS transistor N1.

The first NMOS transistor N1 receives the complementary signal ctl1b of the first control signal through the gate thereof from the driver control section 110, wherein a first terminal of the first NMOS transistor N1 is connected to the second terminal of the first PMOS transistor P1, and a second terminal of the first NMOS transistor N1 is connected to the first negative driver 123.

In addition, the second terminal of the first PMOS transistor P1 and the first terminal of the first NMOS transistor N1 are connected to each other, wherein, from a connection node Node 1 between the second terminal of the first PMOS transistor P1 and the first terminal of the first NMOS transistor N1, output data Output1 is transferred to the electronic paper display device 180.

The first positive driver 121 is supplied with a positive voltage VPOS and is driven, and is connected to the first terminal of the first PMOS transistor P1.

Although input signals inputted to the positive drivers and negative drivers are not shown in FIG. 1, the first positive driver 121 receives input data from a circuit, such as an input decoder, and is driven; and is connected with the first negative driver 123 by the first switching module 122 so as to generate final output data Output1 to be provided to the electronic paper display device 180.

In addition, the first positive driver 121 to an N^{th} positive driver 141 receive the same input data. Connection nodes Node1 of switching modules 122, 132, . . . , 142 connected to positive drivers 121, 131, . . . , 141, respectively, are connected between the driver units 120, 130, . . . , 140, thereby providing the same output data Output1 to the electronic paper display device 180.

The first negative driver 123 is supplied with a negative voltage VNEG and is driven, and is connected to the second terminal of the first NMOS transistor N1.

Similarly to the first positive driver 121, the first negative driver 123 receives input data from a circuit, such as an input decoder, and is driven; and is connected with the first positive driver 121 so as to generate final output data Output1 to be provided to the electronic paper display device 180.

The first negative driver 123 to an N^{th} negative driver 143 receive the same input data.

However, it goes without saying that input data inputted to output driver sections corresponding to the respective outputs are different from each other. For example, input data inputted to the output driver section 120, 130, . . . , 140 to provide output data Output1 is a different signal from input data inputted to the output driver section 150, 160, . . . , 170 to provide output data OutputM.

The positive voltage VPOS is a positive voltage or a voltage higher than the negative voltage VNEG. The negative voltage VNEG is a negative voltage or a voltage lower than the positive voltage VPOG.

The driver control section 110 outputs a plurality of control signals ctl1, ctl2, ctl3, ctl1b, ctl2b, and ctl3b in order to selectively drive the output driver section 120, 130, . . . , 140. The control signals outputted from the driver control section 110 include a first control signal ctl1 to an N^{th} control signal ctl3, and a complementary signal ctl1b of the first control signal and a complementary signal ctl3b of the N^{th} control signal.

The control signals include N number of control signals ctl1, ctl2, and ctl3, and complementary signals ctl1b, ctl2b, and ctl3b of the N control signals. When each driver unit is driven by one control signal and the complementary signal of the control signal, as shown in FIG. 1, N number of control signals are required because N number of driver units are included.

The second driver unit 130 to the N^{th} driver unit 140 respectively have the same construction as that of the first driver unit 120, including a positive driver, a negative driver, and a switching module, except that control signals provided to the second driver unit 130 to N^{th} driver unit 140 from the driver control section 110 are different from that provided to the first driver unit 120. That is to say, the second driver unit 130 is provided with the second control signal ctl2 and the complementary signal ctl2b of the second control signal ctl2, and the N^{th} driver unit 140 is provided with the N^{th} control signal ctl3 and the complementary signal ctl3b of the N^{th} control signal ctl3.

The first driver unit 120 to the N^{th} driver unit 140 can be adjusted to have the same or different driving capabilities.

Also, the output terminals of the first driver unit 120 to the N^{th} driver unit 140 are all connected in common to each other, and the output signals Output1, . . . , OutputM from the output terminals are input to the electronic paper display device 180.

In addition, the output driver section is constructed for every output Output1, . . . , OutputM of the electronic paper display device 180. That is to say, referring to FIG. 1, since the output driver section is configured for every output Output1, . . . , OutputM, M number of output driver sections are included in the output driver.

Here, the first driver unit 120 to the N^{th} driver unit 140 are designed to be configured with transistors of different-sizes, respectively, so that the output driver can be applied to all electronic paper display devices which have mutually different resistor-capacitor (RC) output load values. As a result, even in manufactures which include electronic paper display devices having mutually different RC output loads, respectively, it is possible to provide output data of an equal size to any electronic paper display device by installing the output driver and selectively driving the first driver unit 120 to the N^{th} driver unit 140.

For example, for an electronic paper display device having an output load value of a first output impedance, the output driver may be adjusted to turn on the first driver unit 120 and the N^{th} driver unit 140, and to turn off the remaining driver units so as to output the output data to the corresponding electronic paper display device; while, for an electronic paper display device having an output load value of a second output impedance, the output driver may be adjusted to turn on only the second driver unit 130, and to turn off the remaining driver units so as to output the output data to the corresponding electronic paper display device. As a result, it is possible to adjust the driving capacity of the output driver to any one of electronic paper display devices having mutually different output impedances.

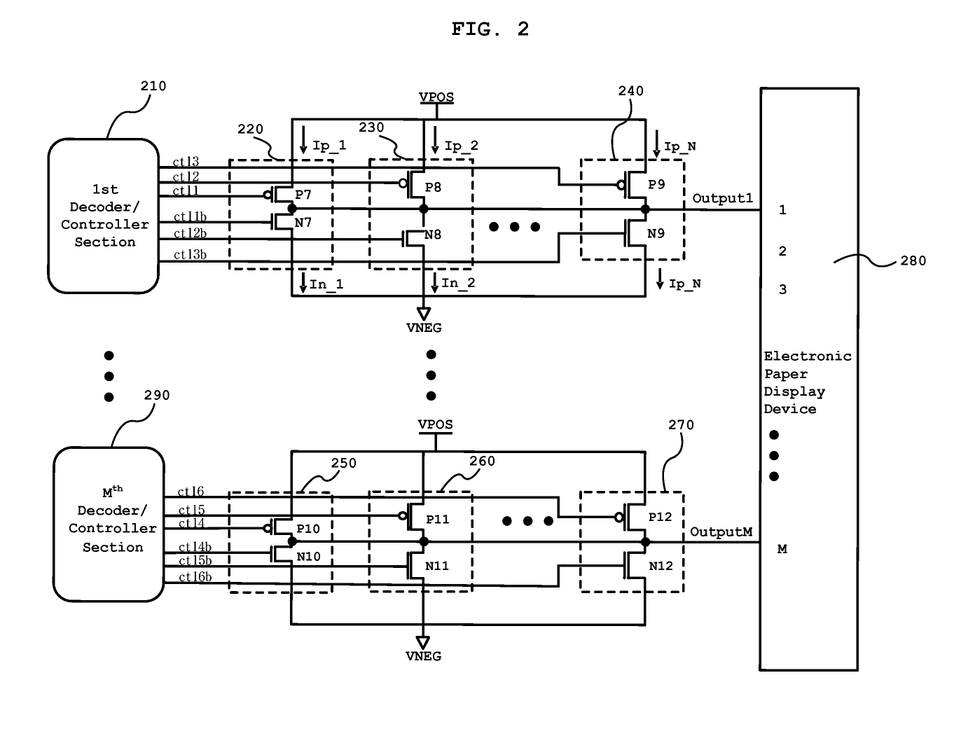

FIG. 2 is a view illustrating the configuration of an output driver of an electronic paper display device according to a second embodiment of the present invention and an electronic paper display device 280.

The output driver of an electronic paper display device, shown in FIG. 2, includes a decoder/controller section 210 and a switching section 220, 230, and 240.

Differently from the driver control section 110 shown in FIG. 1, the decoder/controller section 210 performs all of the function of the output driver section, the function of a data decoder, and the function of the driver control section shown in FIG. 1, thereby outputting a plurality of control signals ctl1, ctl2, ctl3, ctl1b, ctl2b, and ctl3b.

The function of a data decoder is for a circuit, such as an input decoder, to provide input data. The function of the output driver section is, for example, to receive the input data and to perform a driving operation.

Therefore, the decoder/controller section 210 is a circuit for generating a merged value of output signals of the driver control section, shown in FIG. 1, and a result value, which is obtained by receiving input data and performing a driving function on partial components, thereby generating a plurality of control signals ctl1, ctl2, ctl3, ctl1b, ctl2b, and ctl3b.

The switching section 220, 230, and 240 includes a first switching module 220 to an N^{th} switching module 240.

For example, the first switching module 220 includes a seventh PMOS transistor P7 and a seventh NMOS transistor N7.

The seventh PMOS transistor P7 is supplied with the positive voltage VPOS through a first terminal thereof, and receives the control signal ctl1 through the gate thereof, wherein a second terminal of the seventh PMOS transistor P7 is connected to a first terminal of the seventh NMOS transistor N7.

The seventh NMOS transistor N7 is supplied with the negative voltage VNEG through a second terminal thereof, and receives the complementary signal ctl1b of the control signal through the gate thereof, wherein the first terminal of the seventh NMOS transistor N7 is connected to the second terminal of the seventh PMOS transistor P7.

In this case, the first switching module 220 to the N^{th} switching module 240 are selectively driven by the control signals ctl1, ctl2, ctl3, ctl1b, ctl2b, and ctl3b.

Here, the first switching module 220 to the N^{th} switching module 240 are designed to be configured with transistors of different-sizes, respectively, so that the output driver can be applied to all electronic paper display devices which have mutually different resistor-capacitor (RC) output load values. As a result, even in manufactures which include electronic paper display devices having mutually different RC output loads, respectively, it is possible to provide output data of an equal size to any electronic paper display device by installing the output driver and selectively driving the first switching module 220 to the N^{th} switching module 240.

For example, for an electronic paper display device having an output load value of a first output impedance, the output driver may be adjusted to turn on only the first switching module 220, and to turn off the remaining driver units so as to output the output data to the corresponding electronic paper display device; while, for an electronic paper display device having an output load value of a second output impedance, the output driver may be adjusted to turn on only the second switching module 230, and to turn off the remaining driver units so as to output the output data to the corresponding electronic paper display device. As a result, it is possible to adjust the driving capacity of the output driver to any one of electronic paper display devices having mutually different output impedances.

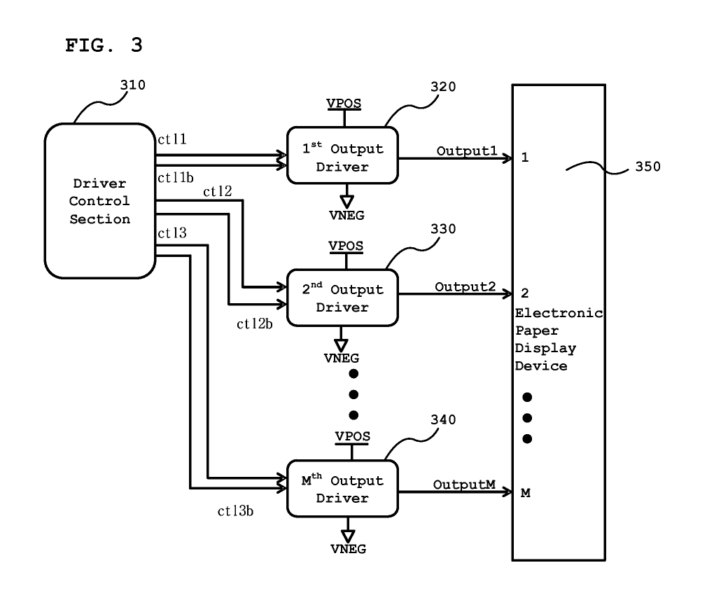

FIG. 3 is a view illustrating the configuration of an output driver of an electronic paper display device according to a third embodiment of the present invention and an electronic paper display device 350.

The output driver of an electronic paper display device, shown in FIG. 3, includes a driver control section 310 and M number of output driver sections 320, 330, . . . , 340.

Also, according to an embodiment of the present invention, the M number of output driver sections 320, 330, . . . , 340 are divided into a plurality of groups so as to be driven according to each group, wherein times at which the respective groups are dispersed, so that peak current is reduced.

For example, when the number of output driver sections, i.e. the number of channels, is 400, the output driver sections are divided into a plurality of groups each of which includes 50 output driver sections, and are sequentially driven in units of 50 output driver sections. As a result, since the 400 number of output driver sections are dispersedly driven 50 output driver sections at a time, peak current is dispersed, so that the peak current can be reduced to approximately one eighth.

The driver control section 310 activates the first control signal ctl1 to the M^{th} control signal ctl3 in regular sequence.

Therefore, the first output driver section 320 to the M^{th} output driver section 340 receive the first control signal ctl1 to the M^{th} control signal ctl3 and the first control signal's complementary signal ctl1b to the M^{th} control signal's complementary signal ctl3b, which are activated in regular sequence, and are sequentially driven, so that it is possible to disperse peak current.

Also, although it is not shown, each of the M number of output driver sections 320, 330, . . . 340, which transmit M number of output data Output1, Output2, . . . , OutputM, respectively, may be dispersedly driven, wherein each of the M number of output driver sections may include N number of driver units therein (wherein “M” and “N” are natural numbers).

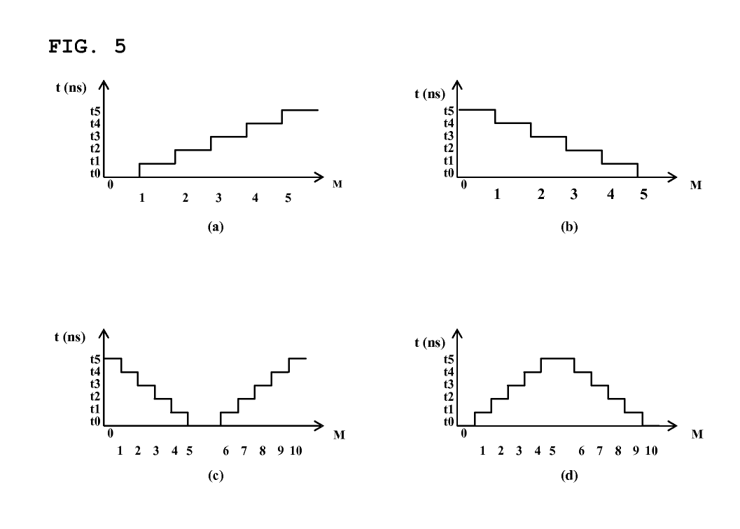

In this document, the term “dispersion driving” represents that output driver sections are driven in regular sequence or are separately driven, like dispersion driving models of output driver sections shown in FIGS. 5A to 5D, so that all output driver sections are not simultaneously driven.

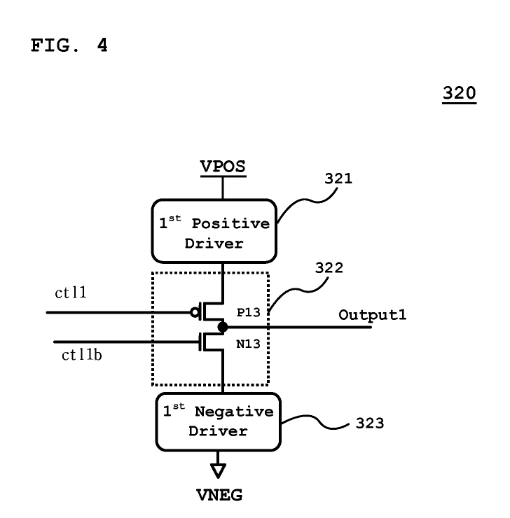

A detailed circuit of each output driver section is shown in FIG. 4 as an example.

FIG. 4 is a detailed circuit diagram of the first output driver section 320 shown in FIG. 3.

The first output driver section 320 includes a first positive driver 321, a first negative driver 323, and a first switching module 322, wherein the switching module 322 includes a 13^{th} PMOS transistor P13 and a 13^{th} NMOS transistor N13.

The 13^{th} PMOS transistor P13 receives a first control signal ctl1 through the gate thereof from the driver control section 310, wherein a first terminal of the 13^{th} PMOS transistor P13 is connected to the first positive driver 321, and a second terminal of the 13^{th} PMOS transistor P13 is connected to a first terminal of the 13^{th} NMOS transistor N13.

The 13^{th} NMOS transistor N13 receives the complementary signal ctl1b of the first control signal through the gate thereof from the driver control section 310, wherein a first terminal of the 13^{th} NMOS transistor N13 is connected to the second terminal of the 13^{th} PMOS transistor P13, and a second terminal of the 13^{th} NMOS transistor N13 is connected to the first negative driver 323.

In addition, the second terminal of the 13^{th} PMOS transistor P13 and the first terminal of the 13^{th} NMOS transistor N13 are connected to each other, wherein, from a connection node between the second terminal of the 13^{th} PMOS transistor P13 and the first terminal of the 13^{th} NMOS transistor N13, output data Output1 is transferred to the electronic paper display device 350.

FIGS. 5A to 5D are views illustrating dispersion driving models of output driver sections shown in FIG. 3.

In FIGS. 5A to 5D, an x axis represents the number of output data, or the number “M” of channels, of the electronic paper display device, and an y axis represents time periods during which the respective output driver sections are driven.

FIG. 5A shows a case where the first output driver section 320 to the M^{th} output driver section 340 are driven in regular sequence. The first output driver section 320 to the M^{th} output driver section 340 are sequentially driven, for example, in such a manner that the first output driver section 320 is driven when 0<t<t1, the second output driver section 330 is driven when t1<t<t2, and the output driver section is driven when t2<t<t3.

FIG. 5B shows a case where the M^{th} output driver section 340 is first driven, and the other output driver sections are driven in reverse order, so that the first output driver section 320 is finally driven.

FIG. 5C shows a case where output driver sections having intermediate numbers are first driven, and specifically, where the output driver sections are gradually driven in order from the output driver sections having intermediate numbers to the first output driver section 320 and the M^{th} output driver section 340.

FIG. 5D shows a case where the first output driver section 320 and the M^{th} output driver section 340 are first driven, and the output driver sections having intermediate numbers are finally driven.

Therefore, according to an embodiment of the present invention, all the output driver sections of an electronic paper display device are driven not simultaneously but consecutively, so that it is possible to reduce peak current.

As is apparent from the above description, the present invention provides an output driver of an electronic paper display device, wherein output driver sections are divided into a plurality of groups and are dispersedly driven, so that peak current can be reduced.

In addition, according to the present invention, drivers included in the output driver are selectively driven according to the sizes of output loads, so that it is possible to provide a constant driving capability although an output load varies.

Although preferred embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. An output driver of an electronic paper display device, the output driver comprising:
M number of output driver sections configured to transmit M number of pieces of data, respectively, to the electronic paper display device (wherein “M” is a natural number more than one),
wherein the M number of output driver sections are divided into a plurality of groups, and are temporally dispersed and driven according to groups, thereby transmitting the M number of pieces of data to the electronic paper display device.

2. The output driver according to claim 1, further comprising a driver control section configured to output a plurality of control signals equal to or less than “M” in order to dispersedly drive the M number of output driver sections,
wherein each of the plurality of control signals is activated for a predetermined period, wherein the plurality of control signals are activated in regular sequence.

3. The output driver according to claim 2, wherein each of the M number of output driver sections comprises:
a positive driver configured to be supplied with a positive voltage and to be driven;
a negative driver configured to be supplied with a negative voltage and to be driven; and
a switching module configured to be connected between the positive driver and the negative driver, and to output the data by connecting or disconnecting the positive driver with the negative according to the control signals.

4. The output driver according to claim 1, wherein each of the M number of output driver sections comprises N number of drivers,
wherein a part of the N number of drivers are selected and driven according to an output impedance of the electronic paper display device.

5. The output driver according to claim 4, wherein the M number of output driver sections comprise a first output driver section to an M^{th} output driver section,
wherein the M number of output driver sections are driven in order from the first output driver section to the M^{th} output driver section, or in order from the M^{th} output driver section to the first output driver section.

6. An output driver for transmitting data to an electronic paper display device, the output driver comprising:
N number of drivers,
wherein a part of the N number of drivers are selected and driven according to an output impedance of the electronic paper display device.

7. The output driver according to claim 6, further comprising a driver control section configured to output a plurality of control signals for selectively driving the N number of drivers.

8. The output driver according to claim 6, wherein the output driver comprises a first driver to an N^{th} driver, and each driver comprises:
a positive driver configured to be supplied with a positive voltage and to be driven;
a negative driver configured to be supplied with a negative voltage and to be driven; and
a switching module configured to be connected between the positive driver and the negative driver, and to output the data by connecting or disconnecting the positive driver with the negative according to the control signals.

9. The output driver according to claim 8, wherein the switching module comprises:
a first PMOS transistor configured to receive a control signal through a gate of the first PMOS transistor from the driver control section, and to have a first terminal connected to the positive driver; and
a first NMOS transistor configured to receive a complementary signal of the control signal through a gate of the first NMOS transistor from the driver control section, to have a first terminal connected to a second terminal of the first PMOS transistor, and to have a second terminal connected to the negative driver,
wherein the data is output from second terminal of the first PMOS transistor, that is, the first terminal of the first NMOS transistor.

10. The output driver according to claim 6, further comprising a decoder/controller section configured to output a plurality of control signals for dispersedly driving the output driver, the output driver comprising a first switching module to an N^{th} switching module,
wherein the first switching module to the N^{th} switching module are supplied with a positive voltage and a negative voltage as a power source, and transmit the data to the electronic paper display device according to the control signals.

11. The output driver according to claim 10, wherein the decoder/controller section further comprises: an input decoder function configured to provide input data; and a function of a circuit configured to receive the input data, to be driven, and to output the input data.

12. The output driver according to claim 11, wherein the first switching module comprises:
a second PMOS transistor configured to receive a control signal through a gate of the second PMOS transistor from the driver control section, and to have a first terminal connected to the positive driver; and
a second NMOS transistor configured to receive a complementary signal of the control signal through a gate of the second NMOS transistor from the driver control section, to have a first terminal connected to a second terminal of the second PMOS transistor, and to have a second terminal connected to the negative driver,
wherein the data is output from second terminal of the second PMOS transistor, that is, the first terminal of the second NMOS transistor.
